(19) United States
(12) Patent Application Publication
(10) Pub. No.: US 2004/0230984 A1
(43) Pub. Date: Nov. 18, 2004

(54) System and method for web application propagation

(76) Inventors: Wayne M. Adams, Boulder, CO (US); Peter Laird, Superior, CO (US); Tanya Saarva, Boulder, CO (US)

Correspondence Address: FLIESLER MEYER, LLP, FOUR EMBARCADERO CENTER, SUITE 400, SAN FRANCISCO, CA, 94111, US

(21) Appl. No.: 10/780,454

(22) Filed: Feb. 17, 2004

Related U.S. Application Data
(60) Provisional application No. 60/451,867, filed on Feb. 24, 2003.

(51) Int. Cl. G06F 9/00

(52) U.S. Cl. 719/310

(57) ABSTRACT

A system and method for propagating an application wherein the application includes a plurality of components, said method comprising selecting a destination environment; propagating the components from a source environment to the destination environment according to a set of rules, and wherein the propagation of at least two of the components can be performed in parallel.

### CLAIM OF PRIORITY

This application claims priority from the following application, which is hereby incorporated by reference in its entirety:

SYSTEM AND METHOD FOR WEB APPLICATION PROPAGATION, U.S. Application No. 60/451,867, Inventors: Wayne M. Adams et al., filed on Feb. 24, 2003. (Attorney's Docket No. BEAS-1432US0)

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present invention disclosure relates to tools for staging web applications on a web server.

### BACKGROUND

To support stable production systems, developers of enterprise application software are encouraged to deploy the software in development, staging and production systems. Each system can include one or more servers. A development system is intended for building and testing development software. A staging system is expected to be configured similarly to the production system so that various runtime aspects of the application can be tested before being deployed on the production system. A missing but highly desirable component to complement this strategy is an automatic and systematic means for propagating the application and its resources from one system to the next.

### BRIEF DESCRIPTION OF THE DRAWINGS

FIG. 1 is an illustration of an exemplary system in an embodiment of the invention.

FIG. 2 is a flow chart illustrating exemplary application component processing in an embodiment of the invention.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Application propagation refers to the process of moving an application's components and its configuration information from a source operational environment to a destination operation environment such that the application can execute in the destination environment. In one embodiment, application propagation can be performed without having to bring down the application. By way of a non-exhaustive example, application components and configuration information can include any of the following: binary executable files, J2EE (Enterprise Java) applications, .Net applications, web applications, distributed objects, libraries, configuration files, information in databases including database records, LDAP (Lightweight Directory Access Protocol) information, any type of file (e.g., binary, ASCII, image, sound, multi-media), Java Archives (JARs), XML (Extensible Markup Language) documents, HTML (Hypertext Markup Language) documents, and any other file/resource required by an application. By way of a non-limiting example, an operational environment can include one or more computing devices such as clients, servers, hand-held computers (e.g, PDAs), cellular telephones, digital music players, and/or digital cameras, and wherein the one or more computing devices can be coupled to one another via a bus, shared memory, one or more public or private computer networks, and/or other suitable means.

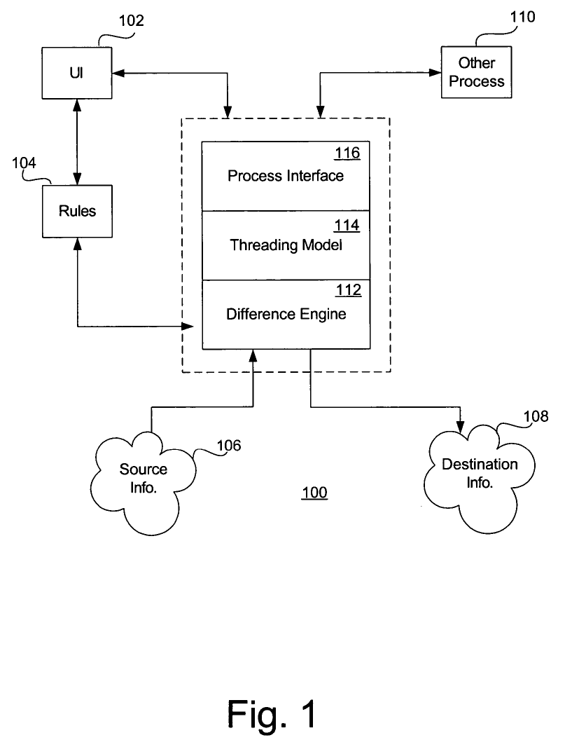

FIG. 1 is an illustration of an exemplary system in an embodiment of the invention. The system propagates an application's components from a source operational environment to a destination operational environment. Although this diagram depicts objects/processes as logically separate, such depiction is merely for illustrative purposes. It will be apparent to those skilled in the art that the objects/processes portrayed in this figure can be arbitrarily combined or divided into separate software, firmware and/or hardware components. Furthermore, it will also be apparent to those skilled in the art that such objects/processes, regardless of how they are combined or divided, can execute on the same computing device or can be distributed among different computing devices connected by one or more networks or other suitable communication means.

In one embodiment, the system can include a user interface (UI) 102. The UI allows a user to interactively control the propagation process, observe its progress, and preview what changes will take place on a destination operational environment. In one embodiment, the UI may be a graphical user interface (GUI). In another embodiment, the UI can be a command line based interface. In another embodiment, the UI can include the ability to respond to sounds (e.g., voice commands), gestures, remote controls (e.g., PDAs), gestures and other suitable means. In another embodiment, the UI can include one or more of the proceeding embodiments.

In another embodiment, a process interface (PI) 116 allows another process 110 on the same or a different computing device to interactively control the system. In another embodiment, the system can be driven by commands in a batch file (not shown).

In one embodiment, the UI/PI has the capability to manually select what application components will be propagated.

In another embodiment, the UI and the PI allow a user or process to create and manipulate a set of propagation rules 104 which are used to guide automatic propagation of application components. By way of a non-limiting example, rules can specify how to handle certain situations and/or be used to explicitly include or exclude components from propagation. A difference engine 112 can propagate an application component from a source environment to a destination environment based on one or more rules within the rule set. In one embodiment, and under control of a threading model 114, multiple instances of the difference engine can execute simultaneously and/or in parallel. By way of a non-limiting example, the threading model can spawn a thread/process to execute an instance of the difference engine for one or more components of the application. Threads/processes can execute on the same computing device or on different computing devices. In this way, the overall time to propagate an application can be reduced.

In one embodiment, the UI/PI has the capability to provide a preview of the changes to a destination environment as a result of propagating an application. This function can be supported by the difference engine wherein the difference engine can determine what changes will be made to the destination without making those changes.

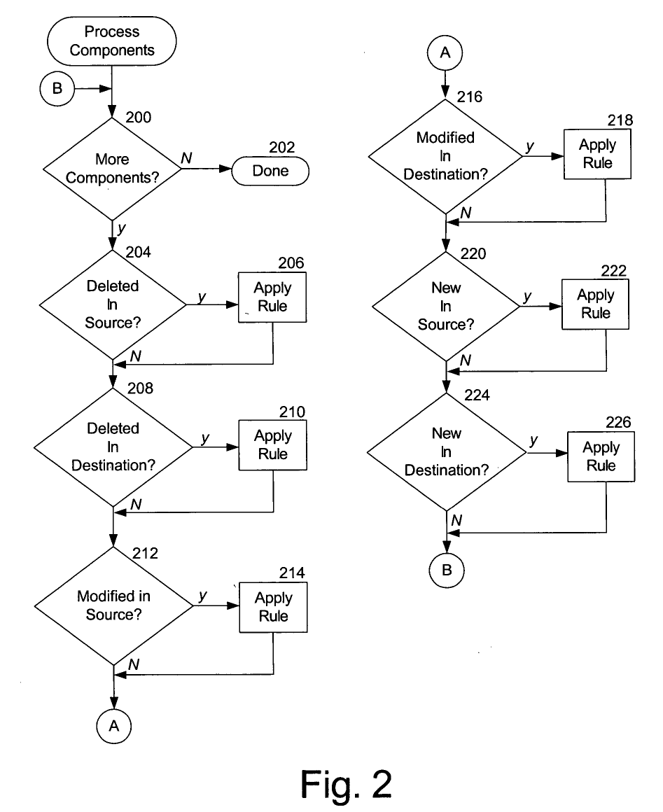

FIG. 2 is a flow chart illustrating exemplary application component processing in an embodiment of the invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In one embodiment, the difference engine can determine how to propagate one or more application component as follows. In step 200, it is determined whether or not there are more components to process. If there are no more components, then the process completes 202. Otherwise, in step 204 it is determined whether or not a given component exists in the destination, but was deleted from the source environment. If this is the case, a rule can be applied in step 206. In one embodiment, the rule can specify whether the difference engine should keep the component in the destination environment or remove it. In another embodiment, the rule can specify whether to prompt a user for a decision. In another embodiment, the rule can specify that no action should be taken. In another embodiment, the rule could initiate further analysis such as consulting an application manifest to determine whether or not the component is still needed for the application to execute.

In step 208, it is determined whether or not a component exists in the source environment but was deleted from the destination environment. If this is the case, a rule can be applied in step 206. In one embodiment, the rule can specify whether the difference engine should copy the component to the destination environment. In another embodiment, the rule can specify whether to prompt a user for a decision. In another embodiment, the rule can specify that no action should be taken. In another embodiment, the rule could initiate further analysis such as consulting an application manifest to determine whether or not the component is still needed for the application to execute.

In step 212, it is determined whether or not a component was modified in the source environment but not in the destination environment. If this is the case, a rule can be applied in step 214. In one embodiment, the rule can specify whether the difference engine should overwrite the component in the destination environment with component from the source environment. In another embodiment, the rule can specify whether to prompt a user for a decision. In another embodiment, the rule can specify that no action should be taken. In another embodiment, the rule could initiate further analysis such as comparing the two components to determine if the differences are insignificant.

In step 216, it is determined whether or not a component was modified in the destination environment but not in the source environment. If this is the case, a rule can be applied in step 218. In one embodiment, the rule can specify whether the difference engine should overwrite the component in the component to the destination environment with the component from the source environment. In another embodiment, the rule can specify whether to prompt a user for a decision. In another embodiment, the rule can specify that no action should be taken. In another embodiment, the rule could initiate further analysis such as comparing the two components to determine if the differences are insignificant.

In step 220, it is determined whether or not a component is new in the source environment but not in the destination environment. If this is the case, a rule can be applied in step 222. In one embodiment, the rule can specify whether the difference engine should copy the new component to the destination environment. In another embodiment, the rule can specify whether to prompt a user for a decision. In another embodiment, the rule can specify that no action should be taken. In another embodiment, the rule could initiate further analysis such as comparing the two components to determine if the differences are insignificant.

In step 224, it is determined whether or not a component is new in the destination environment but not in the source environment. If this is the case, a rule can be applied in step 226. In one embodiment, the rule can specify whether the difference engine should remove the component from the destination environment. In another embodiment, the rule can specify whether to prompt a user for a decision. In another embodiment, the rule can specify that no action should be taken. In another embodiment, the rule could initiate further analysis such as comparing the two components to determine if the differences are insignificant.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method for propagating an application wherein the application includes a plurality of components, said method comprising:
selecting a destination environment;
propagating the components from a source environment to the destination environment according to a set of rules; and
wherein the propagation of at least two of the components can be performed in parallel.

2. The method of claim 1 wherein:
the application can be a web application.

3. The method of claim 1 wherein:
the plurality of components can include at least one of: binary files, J2EE (Enterprise Java) applications, .Net applications, LDAP information, distributed objects, libraries, configuration files, information in databases including database records, Java Archives (JARs), XML (Extensible Markup Language) documents, and HTML (Hypertext Markup Language) documents.

4. The method of claim 1 wherein:
the plurality of components can be distributed on a plurality of source operating environments.

5. The method of claim 1 wherein:
a rule in the set of rules can determine whether the source environment or the destination environment take precedence.

6. The method of claim 1, further comprising:
providing a user interface; and
wherein the user interface can initiate the propagation.

7. The method of claim 6 wherein:
the user interface provides a first user interface to allow a user to create one or more rules in the set of rules.

8. The method of claim 6 wherein:
the user interface provides a first user interface to allow a user to preview the changes that will take place in the destination environment.

9. The method of claim 1, further comprising:
providing a process interface to allow a process to initiate the propagation.

10. The method of claim 1 wherein:
the source and/or destination environment can include a plurality of computing devices.

11. A system for propagating an application wherein the application includes a plurality of components, said system comprising:
a process interface operable to accept propagation requests;
a difference engine operable to propagate the components from a source environment to a destination environment according to a set of rules;
threading model operable to instantiate instances of the difference engine; and
wherein the propagation of at least two of the components can be performed in parallel.

12. The system of claim 11 wherein:
the process interface can accept a request to perform propagation.

13. The system of claim 11 wherein:
the application can be a web application.

14. The system of claim 11 wherein:
the plurality of components can include at least one of: binary files, J2EE (Enterprise Java) applications, .Net applications, LDAP information, distributed objects, libraries, configuration files, information in databases including database records, Java Archives (JARs), XML (Extensible Markup Language) documents, and HTML (Hypertext Markup Language) documents.

15. The system of claim 11 wherein:
the plurality of components can be distributed on a plurality of source operating environments.

16. The system of claim 11 wherein:
a rule in the set of rules can determine whether the source environment or the destination environment take precedence.

17. The system of claim 11, further comprising:
a user interface; and
wherein the user interface can initiate the propagation.

18. The system of claim 17 wherein:
the user interface provides a first user interface to allow a user to create one or more rules in the set of rules.

19. The system of claim 17 wherein:
the user interface provides a first user interface to allow a user to preview the changes that will take place in the destination environment.

20. The system of claim 17 wherein:
the source and/or destination environment can include a plurality of computing devices.

21. A machine readable medium having instructions stored thereon that when executed by a processor cause a system to:
select a destination environment;
propagate a plurality components of an application from a source environment to the destination environment according to a set of rules; and
wherein the propagation of at least two of the components can be performed in parallel.

22. The machine readable medium of claim 21 wherein:
the application can be a web application.

23. The machine readable medium of claim 21 wherein:
the plurality of components can include at least one of: binary files, J2EE (Enterprise Java) applications, .Net applications, LDAP information, distributed objects, libraries, configuration files, information in databases including database records, Java Archives (JARs), XML (Extensible Markup Language) documents, and HTML (Hypertext Markup Language) documents.

24. The machine readable medium of claim 21 wherein:
the plurality of components can be distributed on a plurality of source operating environments.

25. The machine readable medium of claim 21 wherein:
a rule in the set of rules can determine whether the source environment or the destination environment take precedence.

26. The machine readable medium of claim 21, further comprising instructions that when executed cause the system to:
provide a user interface; and
wherein the user interface can initiate the propagation.

27. The machine readable medium of claim 26 wherein:
the user interface provides a first user interface to allow a user to create one or more rules in the set of rules.

28. The machine readable medium of claim 26 wherein:
the user interface provides a first user interface to allow a user to preview the changes that will take place in the destination environment.

29. The machine readable medium of claim 21, further comprising instructions that when executed cause the system to:
provide a process interface to allow a process to initiate the propagation.

30. The machine readable medium of claim 21 wherein:
the source and/or destination environment can include a plurality of computing devices.
